(19) United States
(12) Patent Application Publication
(10) Pub. No.: US 2011/0006679 A1
(43) Pub. Date: Jan. 13, 2011

(54) LED bulb with an enlarged irradiation range by arranging led elements in three-dimension

(76) Inventor: Albert Stekelenburg, Taipei (TW)

Correspondence Address: Guice Patents PLLC, 12647 Galveston Court #302, Manassas, VA, 20112, US

(21) Appl. No.: 12/007,812

(22) Filed: Jan. 15, 2008

(51) Int. Cl. H01J 13/46; F21S 4/00

(52) U.S. Cl. 315/35; 362/249.06

(57) ABSTRACT

An LED light source includes a housing having a base adapted to mount in an electrical socket; a circuit board received in the housing; an electrical circuit assembly received in the housing, the electrical circuit assembly being electrically connected to both the circuit board and the base; an LED assembly mounted on the circuit board, the LED assembly including a plurality of LED elements electrically connected to the circuit board; and a bulb mounted on an open end of the housing for enclosing the circuit board, the electrical circuit assembly, and the LED assembly, wherein the LED elements are arranged in three-dimension so as to irradiate an enlarged range. The LED elements may be arranged and shaped as a tapered tower, a tree, or a semi-sphere.

### BACKGROUND OF THE INVENTION

1. Field of Invention

The invention relates to light sources and more particularly to an LED (light-emitting diode) bulb with an enlarged irradiation range by arranging its LED elements in three-dimension.

2. Description of Related Art

LED lamps have advantages including longer life, less power consumption (i.e., more energy-efficient), and no special ballasts being required. Thus, LED based light sources have gradually replace conventional incandescent lamps and fluorescent lamps as the dominant light sources in our daily life.

Also, LED lamps employing a plurality of LEDs are commercially available. However, the well known LED lamp suffers from a disadvantage. In detail, these LEDs are arranged in two-dimension, i.e., on a plate. Thus, light only directs toward one side of the plate. As a result, side light is relatively weak. Thus, a need for improvement exists.

Also, there have been numerous suggestions in prior patents for LED based light sources. For example, U.S. Pat. No. 5,688,042 discloses an LED lamp and U.S. Pat. No. 7,086,767 discloses an LED bulb

### SUMMARY OF THE INVENTION

It is therefore one object of the invention to provide an LED bulb having an enlarged irradiation range by arranging its LED elements in three-dimension.

In one aspect of the invention the LED elements are arranged and shaped as an upwardly tapered tower, a tree, or a semi-sphere so as to diffuse light through the transparent bulb without being blocked.

The above and other objects, features and advantages of the invention will become apparent from the following detailed description taken with the accompanying drawings.

### BRIEF DESCRIPTION OF THE DRAWINGS

FIG. 1 is a side elevation of a preferred embodiment of LED bulb according to the invention;

FIG. 2 is a longitudinal sectional view of the LED bulb of FIG. 1; and

FIG. 3 is an exploded view of the LED bulb of FIG. 1.

### DETAILED DESCRIPTION OF THE INVENTION

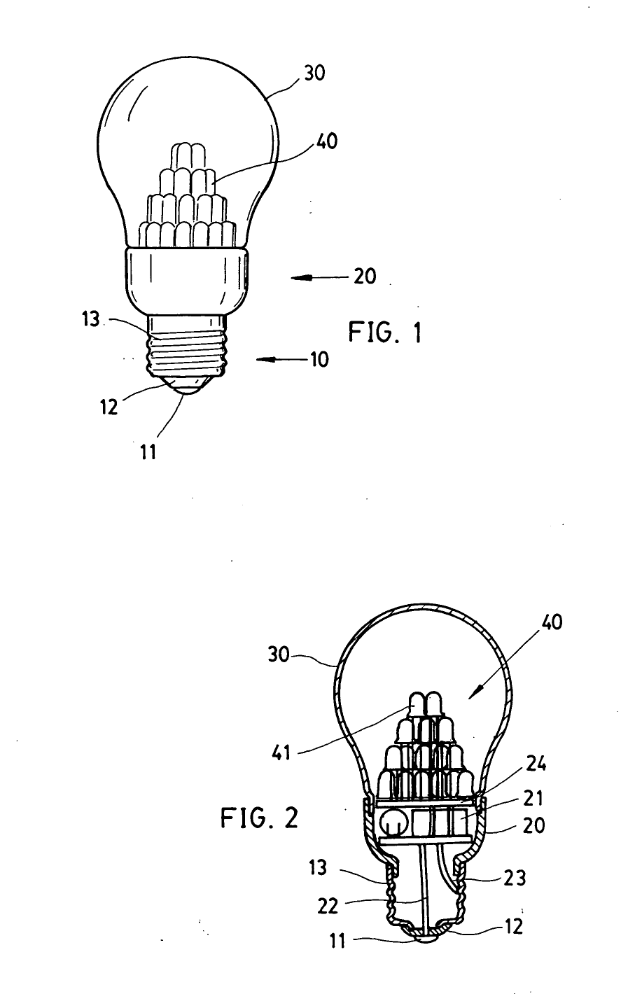

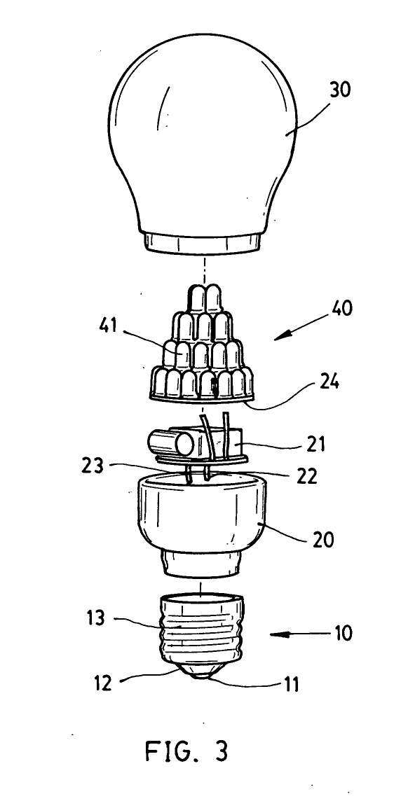

Referring to FIGS. 1 to 3, an LED bulb in accordance with a preferred embodiment of the invention comprises a base 10, a housing 20, a bulb 30, and an LED assembly 40. Each component is discussed in detail below.

The base 10 is a well known device and is adapted to mount in an electrical socket. The base 10 comprises a bottom contact 11 as, for example, positive terminal, a metallic element 13 formed of copper, the metallic element 13 being used as, for example, negative terminal, and an insulator 12 formed between the contact 11 and the metallic element 13 for preventing them from electrically contacting each other.

The hollow housing 20 is adapted to mount on the base 10. Within the housing 20 there are provided an electrical circuit assembly 21 including well known elements such as a capacitor, a resistor, and diodes; two spaced conductors 22, 23 in which the conductor 22 interconnects the electrical circuit assembly 21 and the contact 11 and the conductor 23 interconnects the electrical circuit assembly 21 and the metallic element 13 respectively; and a circuit board 24 mounted on and electrically connected to the electrical circuit assembly 21.

The LED assembly 40 comprises a plurality of LED elements 41. The LED assembly 40 is mounted on the circuit board 24 so that the LED elements 41 can be electrically connected to the circuit board 24.

The bulb 30 can be made of one of a variety of materials. For example, the bulb 30 is made of glass as to be clear or is frosted to diffuse the light. The bulb 30 is mounted on a top edge of the housing 20 so as together with the housing 20 to receive the LED assembly 40, the electrical circuit assembly 21, and the circuit board 24.

The characteristic of the invention is that the LED elements 41 are arranged in three-dimension. For example, the LED elements 41 may be arranged and shaped as an upwardly tapered tower (as shown), a tree, or a semi-sphere so as to diffuse light through the glass bulb 30 without being blocked. That is, light is diffused to an enlarged range for irradiation.

While the invention herein disclosed has been described by means of specific embodiments, numerous modifications and variations could be made thereto by those skilled in the art without departing from the scope and spirit of the invention set forth in the claims.

What is claimed is:

1. An LED assembly for use with an LED light source, comprising a plurality of LED elements electrically connected together wherein the LED elements are arranged in three-dimension.

2. An LED light source comprising:
a housing having a base adapted to mount in an electrical socket;
a circuit board received in the housing;
an electrical circuit assembly received in the housing, the electrical circuit assembly being electrically connected to both the circuit board and the base;
an LED assembly mounted on the circuit board, the LED assembly including a plurality of LED elements electrically connected to the circuit board; and
a bulb mounted on an open end of the housing for enclosing the circuit board, the electrical circuit assembly, and the LED assembly,
wherein the LED elements are arranged in three-dimension.

3. The LED light source of claim 2, wherein the LED elements are arranged and shaped as a tapered tower.

4. The LED light source of claim 2, wherein the LED elements are arranged and shaped as a tree.
